(19) United States
(12) Patent Application Publication
(10) Pub. No.: US 2012/0121487 A1
(43) Pub. Date: May 17, 2012

(54) ELECTRONIC SYSTEM WITH VENTILATION PATH THROUGH INLET-POSITIONED EHD AIR MOVER, OVER OZONE REDUCING SURFACES, AND OUT THROUGH OUTLET-POSITIONED HEAT EXCHANGER

(75) Inventors: Nels Jewell-Larsen, San Jose, CA (US); Kenneth A. Honer, Santa Clara, CA (US); Matthew K. Schwiebert, Cupertino, CA (US)

(73) Assignee: TESSERA, INC., San Jose, CA (US)

(21) Appl. No.: 13/289,870

(22) Filed: Nov. 4, 2011

Related U.S. Application Data
(60) Provisional application No. 61/412,675, filed on Nov. 11, 2010.
(60) Provisional application No. 61/530,841, filed on Sep. 2, 2011.

(51) Int. Cl. B01D 53/66; B21D 53/02; B01D 53/72; B01D 53/56; B01D 53/50

(52) U.S. Cl. 423/219; 422/176; 422/173; 422/171; 29/890.03

(57) ABSTRACT

An electronic system enclosure houses a plurality of electronic components together presenting one or more surfaces coated with ozone reducing material. An EHD air mover positioned remote from an outlet ventilation boundary of the enclosure motivates air flow through the enclosure along a flow path past the one or more surfaces coated with ozone destructive material over heat transfer surfaces and out through an outlet ventilation boundary of the enclosure.

### CROSS-REFERENCE TO RELATED APPLICATION(S)

The present application claims the benefit of U.S. Provisional Application No. 61/412,675, filed Nov. 11, 2010, and of U.S. Provisional No. 61/530,841, filed Sep. 2, 2011 both of which are incorporated herein in their entireties by reference.

### BACKGROUND

Many devices or systems, whether electronic, optical or mechanical, may include, provide or require forced flow of air or some other fluid. In some cases, the forced flow is useful to cool or otherwise moderate heat evolved by thermal sources within the device or system. In such cases, cooling or thermal moderation may help prevent device overheating, reduce thermal hotspots, provide desired thermal stability for temperature sensitive devices, improve long term reliability or provide other benefits. In some cases, forced flow may be a primary function of the device or system.

It is known in the art to provide cooling air flow using fans, blowers or other similar moving mechanical devices; however, such devices generally have limited operating lifetimes, tend to produce undesired noise or vibration, consume power or suffer from other design problems. In addition, such devices can often impose constraints of geometry, form factor and/or layout in systems for which they provide cooling air flows. These constraints can be particularly problematic in modern consumer electronics devices for which size, and indeed, thinness have become important market differentiators.

In some applications, the use of an ion flow air mover device, such as an electrohydrodynamic (EHD) device or electro-fluid dynamic (EFD) device, may result in improved cooling efficiency and reduced vibrations, power consumption, electronic device temperatures, and noise generation. In such deployments, an EHD air mover may reduce costs, allow for reduced device size, thickness or volume, and may in some cases improve electronic device performance and/or user experience.

In general, EHD technology uses ion flow principles to move fluids (e.g., air molecules). Devices built using the principle of ionic movement of a fluid are variously referred to in the literature as ionic wind machines, electric wind machines, corona wind pumps, electro-fluid-dynamics (EFD) devices, electrostatic fluid accelerators (EFAs), electrohydrodynamic (EHD) thrusters and EHD gas pumps. Some aspects of the technology have also been exploited in devices referred to as electrostatic air cleaners or electrostatic precipitators.

EHD-type air movers and other similar devices can produce ions, charged particulate, electromagnetic interference (EMI), as well as ozone. Some electronic system components may be adversely affected by ozone that may migrate or diffuse throughout a system or enclosure. In some cases, the potential for adverse effects may be accentuated as system form factors and standoffs decrease and as EHD-type air movers or other similar devices are advantageously situated to provide air flows precisely where needed in such designs. Accordingly, improvements are sought in mitigating exposure or the effects of exposure of electronic system components to ozone.

### SUMMARY

The present invention relates generally to integration of EHD-type air movers with electronic systems, and in particular, to techniques for mitigating ozone produced by such EHD air movers.

It has been discovered that ozone may be broken down or otherwise reduce in EHD cooled electronic systems by selective provision of ozone reducing materials on system surfaces downstream of the EHD device. Other air flow constituents such as nitrogen dioxide, sulfur dioxide, and volatile organic compounds can similarly be reduced, sequestered or otherwise mitigated by provision of suitable mitigation materials on system surfaces upstream or downstream of the EHD device, or within the EHD device.

One aspect of the invention features, in some implementations, an electronic system including an enclosure defining inlet and outlet ventilation boundaries and an EHD air mover positioned within the enclosure but remote from the outlet ventilation boundary of the enclosure to motivate air flow through the enclosure along a flow path between the inlet and outlet ventilation boundaries. The system further includes one or more ozone reducing surfaces positioned downstream of the EHD air mover along the flow path but upstream of the outlet ventilation boundary, the surfaces are positioned to expose ozone reducing material to the motivated air flow and substantially reduce ozone in the air flow exiting at the outlet ventilation boundary.

In some implementations, the ozone reducing surfaces exposed to the motivated air flow include one or more of: a printed circuit board coated with, or at least partially formed of, ozone reducing material; and an electromagnetic interference (EMI) shield coated with, or at least partially formed of, ozone reducing material.

In some implementations, the ozone reducing surfaces exposed to the motivated air flow include one or more of: an exposed interior surface of the enclosure coated with, or at least partially formed of, ozone reducing material; and an exposed surface of duct work coated with, or at least partially formed of, ozone reducing material.

In some implementations, the electronic system further includes a heat exchanger positioned in the flow path proximate to the outlet ventilation boundary, wherein the ozone reducing surfaces exposed to the motivated air flow are positioned upstream of the heat exchanger.

In some implementations, the heat exchanger is remote from a heat source within the enclosure but thermally coupled thereto by a heat transfer pathway; and the ozone reducing surfaces exposed to the motivated air flow include surfaces of the heat transfer pathway coated with, or at least partially formed of, ozone reducing material.

In some implementations, the heat transfer pathway includes either or both of a heat pipe and a heat spreader. In some implementations, the heat exchanger is itself coated with, or at least partially formed of, ozone reducing material.

In some implementations, the electronic system further includes additional ozone reducing material exposed to the air flow downstream of the heat exchanger.

In some implementations, the ozone reducing material is catalytic for, or reactive with, ozone generated by operation of the EHD air mover. In some implementations, the ozone reducing material includes one or more of: manganese (Mn); manganese dioxide (MnO₂); gold (Au); silver (Ag); silver oxide (Ag₂O); an oxide of nickel (Ni); activated carbon (C); an oxide of copper (Cu), an oxides of iron (Fe); and an oxide of manganese (Mn) and an oxide of manganese preparation.

In some implementations, the electronic system further includes ozone resistive or tolerant coatings on one or more surfaces exposed to the air flow within the enclosure. In some implementations, the electronic system further includes another component-reducing or component-resistive material exposed to the air flow to mitigate at least one of NO₂, SO₂, and VOC present in the air flow or the effects thereof on the coated surfaces.

In some implementations, the EHD air mover is positioned proximate to the inlet ventilation boundary.

In some implementations, the electronic system is configured as one or more of: a handheld mobile phone or personal digital assistant; a laptop, netbook or pad-type computer; and a digital book reader, media player or gaming device.

In some implementations, the electronic system is configured as one or more of: a display panel; television; desktop computer or server; set-top box; air cleaner; heater; projector; receiver; amplifier or other audio visual equipment.

Another aspect of the invention features, in some implementations, an electronic system including an enclosure defining inlet and outlet ventilation boundaries; an EHD air mover positioned proximate to the inlet ventilation boundary to motivate air flow through the enclosure along a flow path between the inlet and outlet ventilation boundaries; and a heat exchanger positioned in the flow path proximate to the outlet ventilation boundary. The electronic system further includes one or more ozone reducing surfaces positioned along the flow path between the EHD air mover and the heat exchanger to expose ozone reducing material to the motivated air flow and substantially reduce ozone in the air flow exiting at the outlet ventilation boundary.

In some implementations, the ozone reducing surfaces include one or more of: a printed circuit board; an electromagnetic interference (EMI) shield; an exposed interior surface of the enclosure; and an exposed surface of duct work, coated with, or at least partially formed of, ozone reducing material.

In some implementations, the heat exchanger is remote from a heat source within the enclosure but thermally coupled thereto by a heat transfer pathway; and wherein the ozone reducing surfaces exposed to the motivated air flow include surfaces of the heat transfer pathway coated with, or at least partially formed of, ozone reducing material.

In some implementations, the heat transfer pathway includes either or both of a heat pipe and a heat spreader.

In some implementations, the heat exchanger is itself coated with, or at least partially formed of, ozone reducing material.

In some implementations, the electronic system further includes additional ozone reducing material exposed to the air flow downstream of the heat exchanger.

In some implementations, the ozone reducing material is catalytic for, or reactive with, ozone generated by operation of the EHD air mover.

In some implementations, the electronic system further includes ozone resistive or tolerant coatings on one or more surfaces exposed to the air flow within the enclosure.

Another aspect of the invention features, in some applications, a method of making an electronic system. The method includes providing an enclosure including inlet and outlet ventilation boundaries and positioning an EHD air mover within the enclosure but remote from the outlet ventilation boundary of the enclosure to motivate air flow through the enclosure along a flow path between the inlet and outlet ventilation boundaries. The method further includes providing one or more ozone reducing surfaces downstream of the EHD air mover along the flow path but upstream of the outlet ventilation boundary, the surfaces positioned to expose ozone reducing material to the motivated air flow and substantially reduce ozone in the air flow exiting at the outlet ventilation boundary.

In some applications, the method further includes positioning a heat exchanger in the flow path proximate to the outlet ventilation boundary, wherein the ozone reducing surfaces exposed to the motivated air flow are positioned upstream of the heat exchanger.

In some applications, the heat exchanger is itself coated with, or at least partially formed of, ozone reducing material.

Another aspect of the invention features, in some applications, a method of ventilating an electronic system while reducing ozone in air flow exiting an enclosure thereof. The method includes using an EHD air mover positioned within the enclosure but remote from an outlet ventilation boundary to motivate air flow through the enclosure along a flow path between inlet and outlet ventilation boundaries of the enclosure; and catalytically or reactively destroying ozone generated by operation of the EHD air mover using one or more ozone reducing surfaces downstream of the EHD air mover along the flow path but upstream of the outlet ventilation boundary, the surfaces positioned to expose ozone reducing material to the motivated air flow and substantially reduce ozone in the exiting air flow.

In some applications, the method further includes dissipating heat into the motivated air flow using a heat exchanger positioned in the flow path proximate to the outlet ventilation boundary, wherein the ozone reducing surfaces exposed to the motivated air flow are positioned upstream of the heat exchanger.

In some applications, the method further includes catalytically or reactively destroying ozone generated by operation of the EHD air mover at the heat exchanger, wherein surfaces of the heat exchanger are themselves coated with, or at least partially formed of, ozone reducing material.

It has been further discovered that ozone may be broken down or otherwise reduced in EHD cooled electronic systems by selective provision of ozone reducing materials on system surfaces between a heat transfer surface and an EHD air mover remote from the heat transfer surface. In some cases, additional ozone reducing material may be provided downstream of the EHD air mover, e.g., on the heat transfer surface.

Another aspect of the invention features, in some applications, a method of moving air through an electronic system including a plurality of electronic components housed within an enclosure. The method includes presenting ozone reducing material on one or more surfaces of the plurality of electronic components within the enclosure and thermally coupling one or more of the plurality of electronic components to a heat transfer surface positioned proximate an outlet ventilation boundary of the enclosure. The EHD air mover motivates air flow through an inlet ventilation boundary of the enclosure along a flow path past the one or more surfaces coated with ozone destructive material, past the heat transfer surface and out through the outlet ventilation boundary of the enclosure.

In some applications, the heat transfer surface is positioned remote from the thermally coupled one or more of the plurality of electronic components.

In some applications, the method includes presenting ozone tolerant or ozone resistive material on a surface of one or more of the electronic components within the enclosure.

In some applications, the method includes providing a second EHD air mover adjacent a second inlet ventilation boundary of the enclosure to motivate air along a flow path past the one or more surfaces coated with ozone destructive material, past the heat transfer surface and out through the outlet ventilation boundary of the enclosure.

In some embodiments, ozone reducing material is provided on surfaces downstream of the EHD air mover. In some embodiments, at least a portion of either or both of the circuit board or other electronic components and an interior surface of the enclosure or ductwork are coated with a protective coating robust to ozone.

In some cases, the protective coating robust to ozone includes a fluoropolymer of tetrafluoroethylene such as a Teflon® material. In some cases, at least a portion of either or both of the circuit board and an interior surface of the enclosure are coated with an ozone catalytic or reactive material. In some cases, the ozone reducing or ozone resistant material is not provided on connectors for the respective electronic component.

In some embodiments, the electronic system includes a thermal transfer pathway from one or more thermal sources disposed on a circuit board to heat transfer surfaces in a flow path along which fluid flow is motivated by the mechanical or EHD air mover.

In some embodiments, the heat transfer pathway includes either or both of a heat pipe and a heat spreader. In some embodiments, at least a portion of the heat transfer pathway is coated with an ozone catalytic or reactive material.

In some embodiments, multiple EHD air movers may be provided. For example, a first EHD air mover can force air into the enclosure at the inlet of a consumer electronics device, while a second EHD air mover instance exhausts air from the outlet of the device.

These and other embodiments will be understood with reference to the description herein, the drawings and the appended claims.

### BRIEF DESCRIPTION OF THE DRAWINGS

The present invention may be better understood, and its numerous objects, features, and advantages made apparent to those skilled in the art by referencing the accompanying drawings.

FIG. 1 is a depiction of certain basic principles of electrohydrodynamic (EHD) fluid flow.

FIG. 2 is a depiction of one embodiment of an EHD air mover.

FIG. 3A depicts a top view of an electronic system having an EHD air mover and ozone reducing surfaces along the air flow path.

FIG. 3B depicts a top view of an electronic system including ozone reducing surfaces along air flow paths defined by and between an inlet, EHD and outlet.

FIG. 3C depicts a top view of an electronic system including ozone reducing surfaces along air flow paths defined by and between multiple inlets, EHDs and outlets.

FIG. 4 depicts a top view of an example laptop electronic system including an EHD remote from an outlet with ozone reducing surfaces along an air flow path defined by and between an inlet and an outlet.

FIGS. 5A-C depict respective side, front and rear views of a display system including an EHD air mover for moving air flow over ozone reducing surfaces along an air flow path defined between air inlets and outlets.

The use of the same reference symbols in different drawings indicates similar or identical items.

### DETAILED DESCRIPTION

Electrohydrodynamic (EHD) Fluid Acceleration, Generally

Basic principles of electrohydrodynamic (EHD) fluid flow are well understood in the art and, in this regard, an article by Jewell-Larsen, N. et al., entitled “Modeling of corona-induced electrohydrodynamic flow with COMSOL multiphysics” (in the Proceedings of the ESA Annual Meeting on Electrostatics 2008) (hereafter, “the Jewell-Larsen Modeling article”), provides a useful summary. Likewise, U.S. Pat. No. 6,504,308, filed Oct. 14, 1999, naming Krichtafovitch et al. and entitled “Electrostatic Fluid Accelerator” describes certain electrode and high voltage power supply configurations useful in some EHD devices. U.S. Pat. No. 6,504,308, together with sections I (Introduction), II (Background), and III (Numerical Modeling) of the Jewell-Larsen Modeling article are hereby incorporated by reference herein for all that they teach.

EHD fluid mover designs described herein can include one or more corona discharge-type emitter electrodes. In general, such corona discharge electrodes include a portion (or portions) that exhibit(s) a small radius of curvature and may take the form of a wire, rod, edge or point(s). Other shapes for the corona discharge electrode are also possible; for example, the corona discharge electrode may take the shape of barbed wire, wide metallic strips, and serrated plates or non-serrated plates having sharp or thin parts that facilitate ion production at the portion of the electrode with the small radius of curvature when high voltage is applied. In general, corona discharge electrodes may be fabricated in a wide range of materials. For example, in some embodiments, compositions such as described in U.S. Pat. No. 7,157,704, filed Dec. 2, 2003, entitled “Corona Discharge Electrode and Method of Operating the Same” and naming Krichtafovitch et al. as inventors may be employed. U.S. Pat. No. 7,157,704 is incorporated herein for the limited purpose of describing materials for some emitter electrodes that may be employed in some corona discharge-type embodiments. In general, a high voltage power supply creates the electric field between corona discharge electrodes and collector electrodes.

EHD fluid mover designs described herein include ion collection surfaces positioned downstream of one or more corona discharge electrodes. Often, ion collection surfaces of an EHD fluid mover portion include leading surfaces of generally planar collector electrodes extending downstream of the corona discharge electrode(s). In some cases, collector electrodes may do double-duty as heat transfer surfaces. In some cases, a fluid permeable ion collection surface may be provided.

Basic principles of EHD fluid flow are reasonably well understood by persons of skill in the art. Accordingly, a brief illustration of ion flow using corona discharge principles in a simple two electrode system sets the stage for the more detailed description that follows.

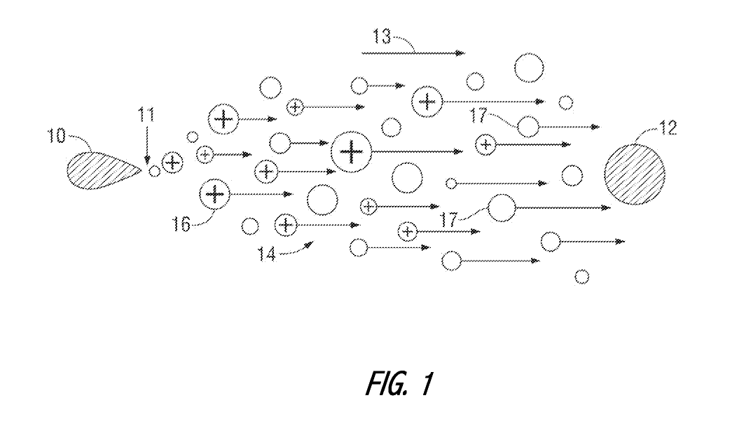

With reference to the illustration in FIG. 1, EHD principles include applying a high intensity electric field between a first electrode 10 (often termed the “corona electrode,” the “corona discharge electrode,” the “emitter electrode” or just the “emitter”) and a second electrode 12. Fluid molecules, such as surrounding air molecules, near the emitter discharge region 11, become ionized and form a stream 14 of ions 16 that accelerate toward second electrode 12, colliding with neutral fluid molecules 17. During these collisions, momentum is imparted from the stream 14 of ions 16 to the neutral fluid molecules 17, inducing a corresponding movement of fluid molecules 17 in a desired fluid flow direction, denoted by arrow 13, toward second electrode 12. Second electrode 12 may be variously referred to as the “accelerating,” “attracting,” “target” or “collector” electrode. While stream 14 of ions 16 is attracted to, and generally neutralized by, second electrode 12, neutral fluid molecules 17 continue past second electrode 12 at a certain velocity. The movement of fluid produced by EHD principles has been variously referred to as “electric,” “corona” or “ionic” wind and has been defined as the movement of gas induced by the movement of ions from the vicinity of a high voltage discharge electrode 10.

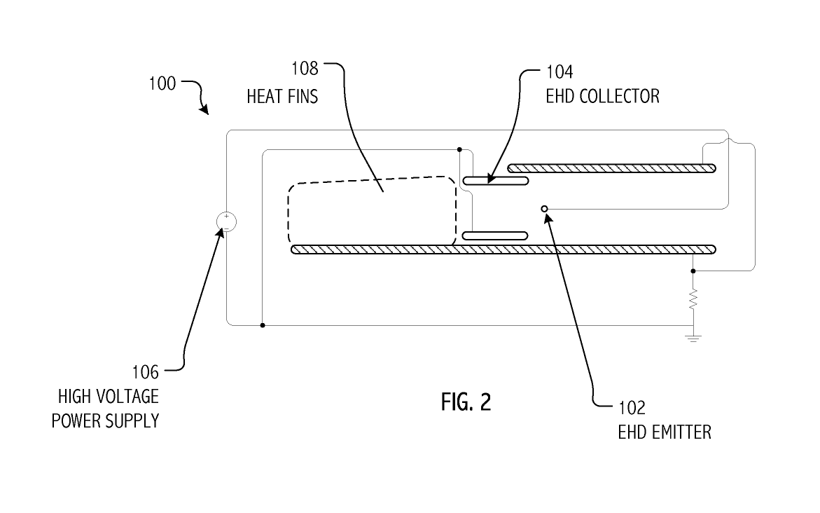

With reference to FIG. 2, a particular example of an EHD air mover embodiment 100 is illustrated in which emitter electrodes 102 and collector electrodes 104 are energized by a high voltage power supply 106 to motivate fluid flow over heat transfer surfaces 108, e.g., heat fins, a heat pipe, or a heat spreader. Typically the motivated fluid is air, although in some embodiments, particular sealed enclosure embodiments, other fluids with constituents not necessarily typical of air, may be used.

In the present application, some aspects of embodiments illustrated and described herein are referred to as electrohydrodynamic fluid accelerator devices, also referred to as “EHD devices,” “EHD fluid accelerators,” “EHD fluid movers,” and the like. For concreteness, some embodiments are described relative to particular EHD device configurations in which a corona discharge at or proximate to an emitter electrode operates to generate ions that are accelerated in the presence of electrical fields, thereby motivating fluid flow. While corona discharge-type devices provide a useful descriptive context, it will be understood (based on the present description) that other ion generation techniques may also be employed. For example, in some embodiments, techniques such as silent discharge, AC discharge, dielectric barrier discharge (DBD), or the like, may be used to generate ions that are in turn accelerated in the presence of electrical fields and motivate fluid flow.

In general, a variety of scales, geometries and other design variations are envisioned for electrostatically operative surfaces that functionally constitute a collector electrode, together with a variety of positional interrelationships between such electrostatically operative surfaces and the emitter and/or collector electrodes of a given EHD device. For example, in some embodiments, opposing planar collector electrodes are arranged as parallel surfaces proximate to a corona discharge-type emitter wire that is displaced from leading portions of the respective collector electrodes. Nonetheless, other embodiments may employ other electrostatically operative surface configurations or other ion generation techniques and will nonetheless be understood in the descriptive context provided herein.

Using heat transfer surfaces that, in some embodiments, take the form of heat transfer fins, heat dissipated by electronics (e.g., microprocessors, graphics units, etc.) and/or other components can be transferred to the motivated air flow and exhausted from an enclosure through a ventilation boundary. Typically, when a thermal management system is integrated into an operational environment, heat transfer paths (often implemented as heat pipes or using other technologies) are provided to transfer heat from where it is dissipated (or generated) to a location (or locations) within the enclosure where air flow motivated by an EHD air mover (or mechanical air mover) flows over heat transfer surfaces.

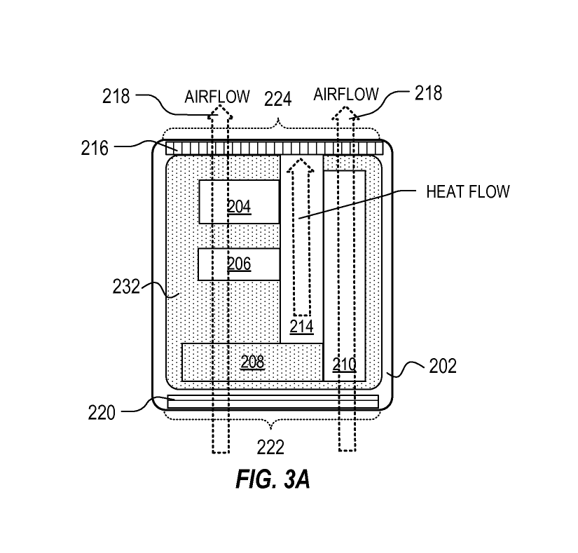

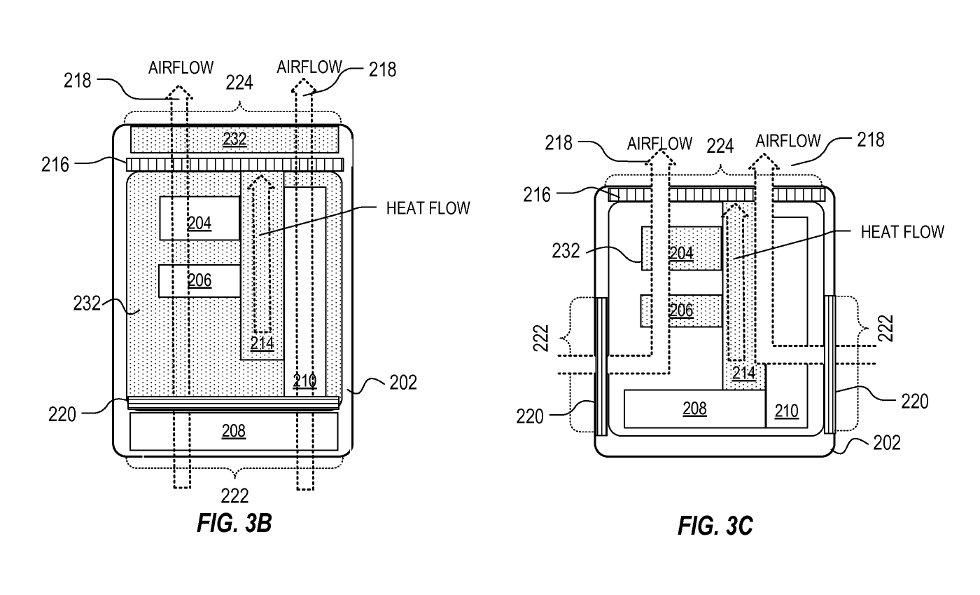

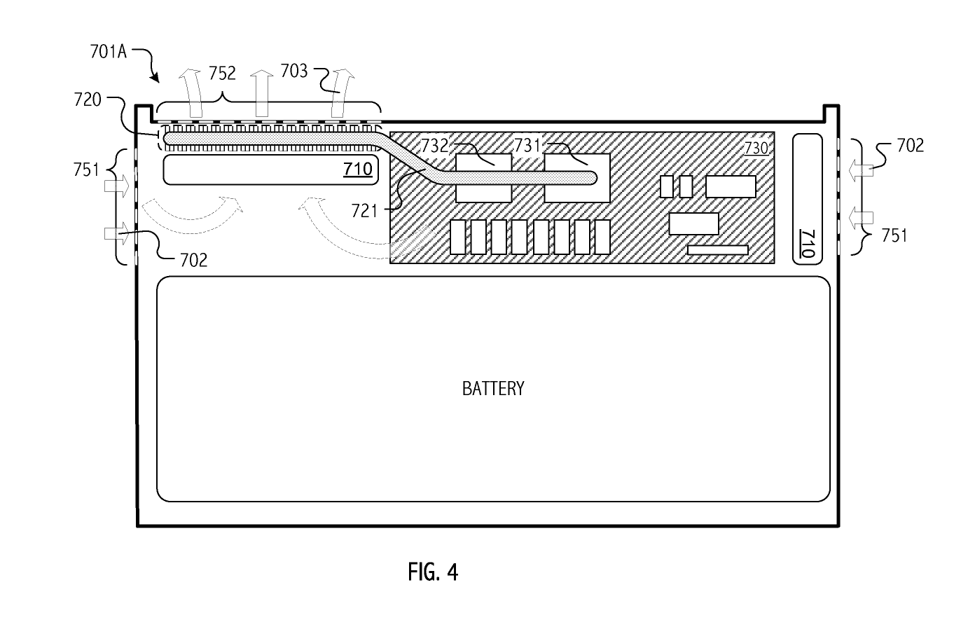

With reference to FIG. 3A, an electronic system 200 includes an enclosure 202 housing various electronic components, e.g., a microprocessor 204, graphics unit 206, battery 208 and a display illumination source 210, any or all of which may generate heat during operation of the electronic system. A heat pipe 214 or other heat transfer path conveys heat from the one or more electronic components to a heat transfer surface(s) 216 positioned within an air flow 218 motivated by an EHD air mover 220. Note that heat pipe 214 and layout of components 204-210 are illustrated schematically and are not meant to suggest any particular topology of heat transfer pathways from particular thermal sources to heat transfer surface(s) 216. Rather, based on the description herein, persons of ordinary skill in the art will recognize topological variations suitable for heat transfer needs of particular systems.

The enclosure 202 defines inlet and outlet ventilation boundaries 222 and 224 and the EHD air mover 220 motivates air flow along a flow path between the inlet and outlet ventilation boundaries 222 and 224. The EHD air mover 220 is positioned remote from and upstream of the heat transfer surface 216, e.g., adjacent the inlet boundary 222, to motivate air flow 218 along the flow path between the inlet and outlet ventilation boundaries 222 and 224. In other embodiments, EHD air mover 220 may be spaced apart some distance from inlet ventilation boundary 222.

Enclosure surfaces, duct surfaces, heat transfer surfaces, or electronic component surfaces along the flow path are provided with an ozone reducing material, together an “ozone reducing surface” 232 (indicated by stippling). Ozone reducing surfaces 232 can include ozone catalysts, ozone binders, ozone reactants or other materials suitable to react with, bind to, or otherwise reduce ozone.

In some embodiments, the ozone reducing surfaces 232 include a catalyst selected from a group that includes: manganese (Mn); manganese dioxide (MnO₂); gold (Au); silver (Ag); silver oxide (Ag₂O); and an oxide of nickel (Ni); and an oxide of manganese preparation.

In some embodiments, a first ozone reducing catalyst may be used on one region of ozone reducing surfaces 232 and a different ozone reducing material may be applied to form a second region of ozone reducing surface 232.

Ozone reducing material can be applied to internal surfaces of enclosure 202 and/or to the surface of electronic components (e.g., 204-210) within enclosure 202. Ozone reducing material can additionally be applied to an individual or combination of electronic system components, EMI shielding, internal housing surfaces and the like.

With reference to FIG. 3B, in some embodiments, heat transfer surface(s) 216 may be spaced a distance away from outlet ventilation boundary 224 with additional ozone reducing surfaces 232 downstream of the heat transfer surfaces 216. In some embodiments, heat transfer surfaces 216 can include ozone reducing material, with efficacy of the ozone reducing material being enhanced by heating of heat transfer surfaces 216. Any number of additional surfaces or components can serve as ozone reducing surfaces 232 to present ozone reducing material along the flow path between inlet and outlet boundaries 222 and 224. For example, heat pipe 214 can be provided with ozone reducing material such that heating of heat pipe 214 enhances ozone reduction.

Similarly, surfaces of any number of the electronic components or transfer surfaces within enclosure 202, and even internal enclosure surfaces can be provided with ozone tolerant, or ozone resistant coating to mitigate the effects of ozone.

In some non-illustrated embodiments, heat transfer surface 216, heat pipes, or heat spreaders can be arranged to lie along two edges of enclosure 202, internal plenum 212, or air flow 218, e.g., in curved or L-shaped arrangement. In some embodiments, heat transfer surface 216 is positioned adjacent outlet boundary 224.

In some embodiments, inlet boundary 222 and outlet boundary 224 are of different sizes or throughput capacities. The cross-section of EHD air mover 220 may be selected to be substantially greater than either of inlet 222 or outlet boundary 224, e.g., 25-50 percent greater. Similarly, EHD air mover 220 and heat transfer surface 216 can be sized to provide a desired degree of heat transfer and air throughput. In some cases, a cross-sectional area of EHD air mover 220 is at least 25% greater than a cross-section of the flow path over heat transfer surface(s) 216.

In some embodiments, a longer or wider flow path for air flow 218 is selected to control surface temperature of enclosure 202, e.g., within a temperature range or below a threshold (e.g., 45 degrees Celsius to be comfortable to the touch of the user).

In some embodiments in which the EHD air mover 220 is positioned near inlet ventilation boundary 222, it may be advantageous, e.g., to reduce risk of electric shock, to maintain an emitter electrode near the inlet ventilation boundary 222 at or near ground and apply a higher voltage to a collector electrode of the EHD air mover 220. A grounded emitter electrode could also be used to reduce risk of shock in some embodiments.

Any of a variety of air flow configurations may be provided. For example, and with reference to FIG. 3A, air flow 218 may flow over a broad area of enclosure 202 or, alternatively, across a more limited channel therein. With reference to FIB. 3C, inlets 222 and EHDs 220 can be arranged along the lateral surfaces of enclosure 202 or alternatively along any combination of surfaces, edges, or sides of enclosure 202. In some non-illustrated embodiments, plural EHD air movers 220 may be provided to both push and pull airflow 218 between inlet and outlet boundaries 222 and 224. In some non-illustrated embodiments, a first air flow can be established over a heat transfer surface in thermal communication with electronic components while a second air flow can be established over surfaces of the electronic components with any number of heat transfer or electronic component surfaces serving as ozone reducing surfaces. The first and second air flows can be separate branches of air flow motivated by a single EHD, or alternatively by multiple EHDs. For example, the first and second air flows can be joined upstream of the EHD or can be released through a common outlet.

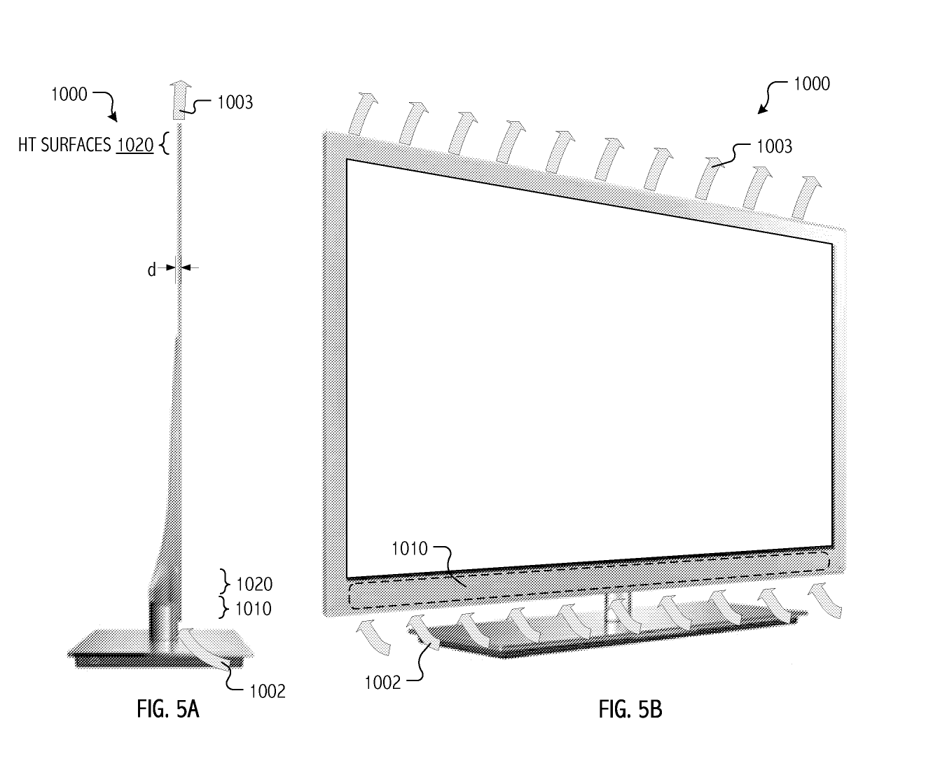

With reference to FIG. 4, an example laptop embodiment is illustrated in top plan view showing air flow topologies and placement of EHD air mover 710 relative to electronic assemblies, such as a circuit board 730 for processors (e.g., CPU, GPU, etc.) and/or radio frequency (RF) sections (e.g., WiFi, WiMax, 3G/4G voice/data, GPS, etc.) are positioned toward an upper edge of body portion 701A and in which certain edge-positioned ventilation boundaries (e.g., inlets 751 and outlet 752) are provided. In the views of FIG. 4, a display, keyboard and upper body portion have been omitted to reveal an illustrative interior layout and illustrative internal air flows motivated (i.e., forced or drawn) by EHD air mover 710 over circuit board 730 and/or heat transfer surfaces 720. Heat pipe (or spreader) 721 provides a heat transfer path from selected thermal sources on circuit board 730 (e.g., CPU 731 and graphics unit 732) to heat transfer surfaces 720, while air flows motivated over circuit board 730 by EHD air mover 710 provide additional cooling. Circuit board 730 and/or any number of associated electronic components or housing surfaces downstream of EHD 710 are provided with ozone reducing or ozone resistant material. Thus, ozone generated by EHD 710 is catalyzed or otherwise reduced by selected materials presented on ozone reducing surfaces along the air flow path.

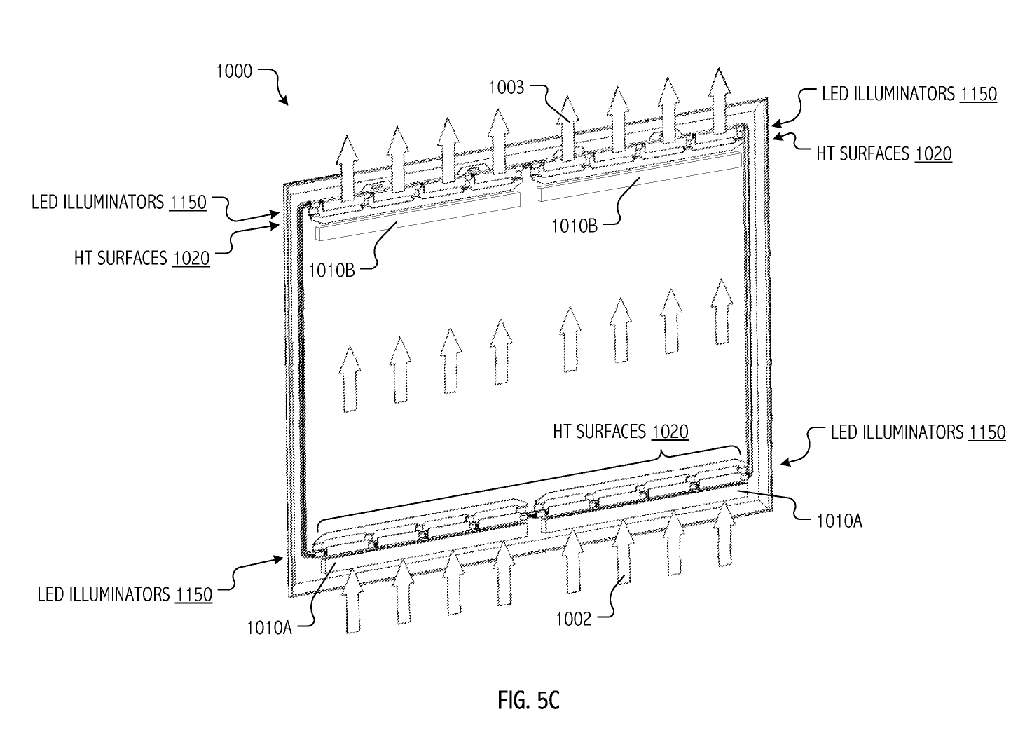

Turning to still another type of electronic system contemplated, FIGS. 5A and 5B are respective edge-on side and perspective views of an illustrative, flat panel display style, low-profile consumer electronics device 1000 in which, in accord with some embodiments of the present invention, an EHD fluid mover 1010 is accommodated within a body portion having total thickness d of less than about 10 mm. FIG. 10A illustrates exemplary inflows 1002 and outflows 1003 that may be motivated through the consumer electronics device by EHD air movers 1010.

Of course, positions illustrated for inflow(s), outflow(s) and heat transfer surfaces 1020 are purely exemplary and, more generally, ventilation boundaries may be dictated by interior placement of components, thermal challenges of a particular device configuration and/or industrial design factors. FIG. 5C depicts one embodiment generally in accord with FIGS. 5A and 5B, in which elongate, edge-positioned arrays of illumination sources (LED illuminators 1150) generate heat which, during operation, is convectively transferred by way of heat transfer surfaces 1020 into air flows (1002, 1003) motivated by EHD air movers 1010A, 1010B. In the illustrated configuration, bottom-mounted EHD air mover instances (1010A) force air into the enclosure at the bottom of consumer electronics device 1000, which passes over ozone reducing surface 1032 and is exhausted from the top.

Ozone reducing or ozone resistant material 1032 may be provided on heat surfaces 1020, circuit board (not shown), heat transfer surfaces and/or on broad surfaces of the display or housing exposed to the air flow. Thus, EHD air movers 1010 and 1010A motivate air along a flow path in contact with the ozone reducing material to reduce ozone evolved by an EHD air mover, or otherwise present in the air flow. In some embodiments, some display system components are coated with an ozone reducing material while other display system components are coated with one or more ozone resistant or tolerant materials. Ozone robust or resistive coatings or catalytic coatings or conditioning materials may be applied to any number of EHD or system component surfaces. For example, a dielectric coating can be selected or configured to be resistant to degradation in an ozone containing fluid.

As in previously described laptop-style designs, emitter electrode instances may, in some embodiments, be coupled to a positive high voltage terminal of a power supply (illustratively +3.5 KV, although specific voltages and, indeed, any supply voltage waveforms may be matters of design choice) while collector electrodes instances are coupled to a local ground. In some embodiments, the emitter electrode may be grounded while the collector electrode is coupled to a negative high voltage terminal. Operation of EHD air movers 1010A is substantially as described with reference to FIG. 2.

Some embodiments of thermal management systems described herein employ EFA or EHD devices to motivate flow of a fluid, typically air, based on acceleration of ions generated as a result of corona discharge. Other embodiments may employ other ion generation techniques and will nonetheless be understood in the descriptive context provided herein. Using heat transfer surfaces, heat dissipated by electronics (e.g., microprocessors, graphics units, etc.) and/or other electronic system components can be transferred to the fluid flow and exhausted. Heat transfer paths, e.g., heat pipes, are provided to transfer heat from where it is generated within the internal plenum to a location(s) within the enclosure where air flow motivated by an EHD device(s) flows over heat transfer surfaces to dissipate the heat.

In some embodiments, an EFA or EHD air cooling system or other similar ion action device may be integrated in an operational system such as a laptop, tablet or desktop computer, a projector or video display device, etc., while other embodiments may take the form of subassemblies. Various features may be used with different devices including EFA or EHD devices such as air movers, film separators, film treatment devices, air particulate cleaners, photocopy machines and cooling systems for electronic devices such as computers, laptops and handheld devices. One or more devices includes one of a computing device, projector, copy machine, fax machine, printer, radio, audio or video recording device, audio or video playback device, communications device, charging device, power inverter, light source, medical device, home appliance, air cleaner, space heater, power tool, toy, game console, set-top console, television, and video display device.

While the foregoing represents a description of various embodiments of the invention, it is to be understood that the claims below recite the features of the present invention, and that other embodiments, not specifically described hereinabove, fall within the scope of the present invention.

What is claimed is:

1. An electronic system comprising:
an enclosure including inlet and outlet ventilation boundaries;
an EHD air mover positioned within the enclosure but remote from the outlet ventilation boundary of the enclosure to motivate air flow through the enclosure along a flow path between the inlet and outlet ventilation boundaries; and
one or more ozone reducing surfaces positioned downstream of the EHD air mover along the flow path but upstream of the outlet ventilation boundary, the surfaces positioned to expose ozone reducing material to the motivated air flow and substantially reduce ozone in the air flow exiting at the outlet ventilation boundary.

2. The electronic system of claim 1, wherein the ozone reducing surfaces exposed to the motivated air flow include one or more of:
a printed circuit board coated with, or at least partially formed of, ozone reducing material; and
an electromagnetic interference (EMI) shield coated with, or at least partially formed of, ozone reducing material.

3. The electronic system of claim 1, wherein the ozone reducing surfaces exposed to the motivated air flow include one or more of:
an exposed interior surface of the enclosure coated with, or at least partially formed of, ozone reducing material;
an exposed surface of duct work coated with, or at least partially formed of, ozone reducing material.

4. The electronic system of claim 1, further comprising:
a heat exchanger positioned in the flow path proximate to the outlet ventilation boundary, wherein the ozone reducing surfaces exposed to the motivated air flow are positioned upstream of the heat exchanger.

5. The electronic system of claim 4,
wherein the heat exchanger is remote from a heat source within the enclosure but thermally coupled thereto by a heat transfer pathway; and
wherein the ozone reducing surfaces exposed to the motivated air flow include surfaces of the heat transfer pathway coated with, or at least partially formed of, ozone reducing material.

6. The electronic device of claim 5,
wherein the heat transfer pathway includes either or both of a heat pipe and a heat spreader.

7. The electronic system of claim 4,
wherein the heat exchanger is itself coated with, or at least partially formed of, ozone reducing material.

8. The electronic system of claim 4, further comprising:
additional ozone reducing material exposed to the air flow downstream of the heat exchanger.

9. The electronic system of claim 1,
wherein the ozone reducing material is catalytic for, or reactive with, ozone generated by operation of the EHD air mover; and
further comprising another component-reducing material exposed to the air flow to mitigate at least one of nitrogen dioxide, sulfur dioxide, and volatile organic compounds present in the air flow.

10. The electronic system of claim 1, wherein the ozone reducing material includes one or more of:
manganese (Mn);
manganese dioxide (MnO₂);
gold (Au);
silver (Ag);
silver oxide (Ag₂O);
an oxide of nickel (Ni);
activated carbon (C);
an oxide of copper (Cu),
an oxide of iron (Fe); and
an oxide of manganese (Mn) preparation.

11. The electronic system of claim 1, further comprising:
ozone resistive or tolerant coatings on one or more surfaces exposed to the air flow within the enclosure.

12. The electronic system of claim 1,
wherein the EHD air mover is positioned proximate to the inlet ventilation boundary.

13. The electronic system of claim 1, configured as one or more of:
a handheld mobile phone or personal digital assistant;
a laptop, netbook or pad-type computer; and
a digital book reader, media player or gaming device.

14. The electronic system of claim 1, configured as one or more of:
a display panel and
a television.

15. The electronic system of claim 1, configured as one of:
a desktop computer or server;
a set-top box;
a receiver, amplifier or other audio visual equipment; and
a projector.

16. An electronic system comprising:
an enclosure including inlet and outlet ventilation boundaries;
an EHD air mover positioned proximate to the inlet ventilation boundary to motivate air flow through the enclosure along a flow path between the inlet and outlet ventilation boundaries;
a heat exchanger positioned in the flow path proximate to the outlet ventilation boundary; and
one or more ozone reducing surfaces positioned along the flow path between the EHD air mover and the heat exchanger to expose ozone reducing material to the motivated air flow and substantially reduce ozone in the air flow exiting at the outlet ventilation boundary.

17. The electronic system of claim 16, wherein the ozone reducing surfaces include one or more of:
a printed circuit board;
an electromagnetic interference (EMI) shield;
an exposed interior surface of the enclosure; and
an exposed surface of duct work, coated with, or at least partially formed of, ozone reducing material.

18. The electronic system of claim 16,
wherein the heat exchanger is remote from a heat source within the enclosure but thermally coupled thereto by a heat transfer pathway; and
wherein the ozone reducing surfaces exposed to the motivated air flow include surfaces of the heat transfer pathway coated with, or at least partially formed of, ozone reducing material.

19. The electronic device of claim 18,
wherein the heat transfer pathway includes either or both of a heat pipe and a heat spreader.

20. The electronic system of claim 16,
wherein the heat exchanger is itself coated with, or at least partially formed of, ozone reducing material.

21. The electronic system of claim 16, further comprising:
additional ozone reducing material exposed to the air flow downstream of the heat exchanger.

22. The electronic system of claim 16,
wherein the ozone reducing material is catalytic for, or reactive with, ozone generated by operation of the EHD air mover.

23. The electronic system of claim 16, further comprising:
ozone resistive or tolerant coatings on one or more surfaces exposed to the air flow within the enclosure.

24. A method of making an electronic system, the method comprising:
providing an enclosure including inlet and outlet ventilation boundaries;
positioning an EHD air mover within the enclosure but remote from the outlet ventilation boundary of the enclosure to motivate air flow through the enclosure along a flow path between the inlet and outlet ventilation boundaries; and
providing one or more ozone reducing surfaces downstream of the EHD air mover along the flow path but upstream of the outlet ventilation boundary, the surfaces positioned to expose ozone reducing material to the motivated air flow and substantially reduce ozone in the air flow exiting at the outlet ventilation boundary.

25. The method of claim 24, further comprising:
positioning a heat exchanger in the flow path proximate to the outlet ventilation boundary, wherein the ozone reducing surfaces exposed to the motivated air flow are positioned upstream of the heat exchanger.

26. The method of claim 24,
wherein the heat exchanger is itself coated with, or at least partially formed of, ozone reducing material.

27. A method of ventilating an electronic system while reducing ozone in air flow exiting an enclosure thereof, the method comprising:
using an EHD air mover positioned within the enclosure but remote from an outlet ventilation boundary to motivate air flow through the enclosure along a flow path between inlet and outlet ventilation boundaries of the enclosure; and
catalytically or reactively destroying ozone generated by operation of the EHD air mover using one or more ozone reducing surfaces downstream of the EHD air mover along the flow path but upstream of the outlet ventilation boundary, the surfaces positioned to expose ozone reducing material to the motivated air flow and substantially reduce ozone in the exiting air flow.

28. The method of claim 27, further comprising:
dissipating heat into the motivated air flow using a heat exchanger positioned in the flow path proximate to the outlet ventilation boundary, wherein the ozone reducing surfaces exposed to the motivated air flow are positioned upstream of the heat exchanger.

29. The method of claim 27, further comprising:
catalytically or reactively destroying ozone generated by operation of the EHD air mover at the heat exchanger, wherein surfaces of the heat exchanger are themselves coated with, or at least partially formed of, ozone reducing material.
